(19) United States
(12) Patent Application Publication
(10) Pub. No.: US 2016/0296840 A1
(43) Pub. Date: Oct. 13, 2016

(54) QUALITY OF EXPERIENCE OPTIMIZATION USING POLICY-BASED DECISION ENGINES

(71) Applicant: InterDigital Patent Holdings, Inc., Wilmington, DE (US)

(72) Inventors: John D. Kaewell, Jamison, PA (US); Shoshana Loeb, Philadelphia, PA (US)

(21) Appl. No.: 15/100,614

(22) PCT Filed: Nov. 24, 2014
(86) PCT No.: PCT/US2014/067159

§ 371 Date: May 31, 2016

Related U.S. Application Data
(60) Provisional application No. 61/910,405, filed on Dec. 1, 2013.

(51) Int. Cl. A63F 13/30; H04L 12/24; H04L 12/825; H04L 12/26; H04L 29/08; H04L 29/06

(52) U.S. Cl. CPC A63F 13/30; H04L 67/1021; H04L 65/602; H04L 47/25; H04L 43/0852; H04L 41/5025; H04L 67/1008

(57) ABSTRACT

Systems and methods are described for managing the configuration of a networked application, such as a networked multi-player game. An optimization server determines a configuration of a networked application, such as information on a mapping between users and application servers. The optimization server receives a plurality of state parameters, such as loading parameters and latency parameters. The optimization server applies a quality of experience policy to determine whether to change the configuration of the network. The optimization server operates to send instructions to effect changes to the configuration of the networked application.

### CROSS-REFERENCE TO RELATED APPLICATIONS

The present application is a non-provisional filing of, and claims benefit under 35 U.S.C. §119(e) from, U.S. Provisional Patent Application Ser. No. 61/910,405, filed Dec. 1, 2013, incorporated herein by reference in its entirety.

### FIELD

This disclosure relates to distributed multi-user applications, such as distributed multiplayer games.

### BACKGROUND

The dominant architecture for multiplayer online real-time games is based on an authoritative server receiving updates from clients (the players) and objects, calculating the global game state and then communicating the game state to the clients, thereby synchronizing the game amongst the multiple clients. The authoritative server architecture makes synchronization of game state across multiple clients easier versus peer-to-peer based synchronization. Also, the authoritative server architecture helps to prevent cheating and facilitates billing.

Multiplayer online games often simulate a virtual spatial world that consists of a static part and a dynamic part. The static part covers the environment such as buildings, landscape and unchangeable or immutable objects. Since the static part is known ahead of time, there does not need to be any information exchanged between the server and the client for the static part during the game. The dynamic part covers objects that can change during the course of the game. Dynamic objects (or mutable objects) include the player's avatar, non-playing characters (NPCs) controlled by the computer and other objects which can change state. Objects that can change state are called entities. The cumulative sum of all of the entities represents the dynamic part of the game world. The dynamic part and the static part together represent the game state that represents the game world at a certain point in time.

A real-time game is driven by a real-time loop that runs continuously on the server. FIG. 2A shows an iteration of the real-time loop. The basic steps of the loop are as follows: step 204, the clients process the user inputs and send the inputs to the server; step 206, the server then determines a new game state by applying the clients' inputs and the game logic including the artificial intelligence of the NPCs; step 208, the server transfers the new game state back to the clients. See, Glinka, High-Level Development of Multiserver Online Games. International Journal of Computer Games Technology, 1-16 (2008), the contents of which are hereby incorporated herein by reference.

It is estimated that the gaming industry will total $70.4 B in 2013 with 1,231,000,000 players worldwide. Online games constituted 31% of total game sales versus 69% media based game sales in 2011. The present Xbox Live online game network is supported by 20,000 servers. The next generation Xbox One is predicted to consist of 500,000 servers. See Saldana, J. &., Tutorial: Traffic of online games. Berlin: IETF 872013 (2013), the contents of which are hereby incorporated herein by reference.

Massive online interactive applications such as multiplayer games, real-time video conferencing and remote learning, collaborative real-time robotics, etc., often suffer from degradation of quality of experience as the sophistication and resource dependency of the application increases, as the number of clients (players) increases, as the reliability of the network decreases, as the location of the users varies and as the capability and location of the servers varies. In view of the present deficiencies associated with online gaming, improvements are needed that provide higher quality user experiences.

### SUMMARY

In various embodiments described herein, communication networks are dynamically configured and parallelized application servers are configured to improve a Quality of Experience (QoE). In some embodiments, the configuration adjustments and alterations are done in real-time to support multi-user online environments. The environments may also be interactive and highly dynamic applications, and wherein the QoE is improved (optimized with respect to one or more criteria) through the use of policy based decision engines that control either the communication network configuration such as to minimize latency and packet errors and/or the distribution and parallel implementation of the application across multiple servers to minimize run-time, latency and power, and to dynamically support varying numbers of users.

Disclosed in one embodiment is a method and a system that obtains a “composite state” of the network, which may include numerous attributes including the application type, user specific-data, and the like, and responsively modifies the communication system and or application deployment such as by re-configuring the communication network and/or re-distributes the app server locations, and/or modifying the resources available to individual users.

Disclosed in a further embodiment is a system and a method that applies pre-defined policies to optimize the reliability and latency between multiple, interactive users and multiple servers that host a distributed implementation of an application based on dynamic global and local states and policies.

In a further embodiment, disclosed is a method and system that determines an application partition and distributes the executable implementation of an application across multiple servers and server locations to optimize run-time and latency through the use of a decision engine which analyzes dynamic global and local states and policies.

In still further embodiments, a method and system is described that utilizes a decision inference engine to make preemptive changes to the communications network and/or multiple server configurations to avoid quality of experience degradation based on global and local state, past (learned) performance and policies.

### BRIEF DESCRIPTION OF THE DRAWINGS

FIG. 1A depicts an exemplary communications system in which one or more disclosed embodiments may be implemented.

FIG. 1B depicts an exemplary wireless transmit/receive unit (WTRU) that may be used within the communications system of FIG. 1A.

FIG. 1C depicts an example radio access network (RAN) and an exemplary core network that may be used within the communications system of FIG. 1A.

FIG. 1D depicts a second example RAN and a second exemplary core network that may be used within the communications system of FIG. 1A.

FIG. 1E depicts a third example RAN and a third exemplary core network that may be used within the communications system of FIG. 1A.

FIG. 2A is a flow diagram illustrating a real-time loop implemented in a gaming server.

FIG. 2B is a schematic block diagram illustrating components of a gaming network.

FIG. 3 is an architectural block diagram of a network including an optimization server in communication with a plurality of gaming servers in accordance with some embodiments.

FIG. 4 is a schematic block diagram of a network entity such as an optimization server that may be used in some embodiments.

FIG. 5 is a functional block diagram of an optimization server in accordance with some embodiments.

FIG. 6 is a functional block diagram of an optimization server in accordance with some embodiments.

FIG. 7 is a flow chart illustrating an optimization method performed in accordance with some embodiments.

FIG. 8 is a flow chart illustrating an optimization method performed in accordance with some embodiments.

FIG. 9 is a flow chart illustrating an optimization method performed in accordance with some embodiments to reduce latency.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

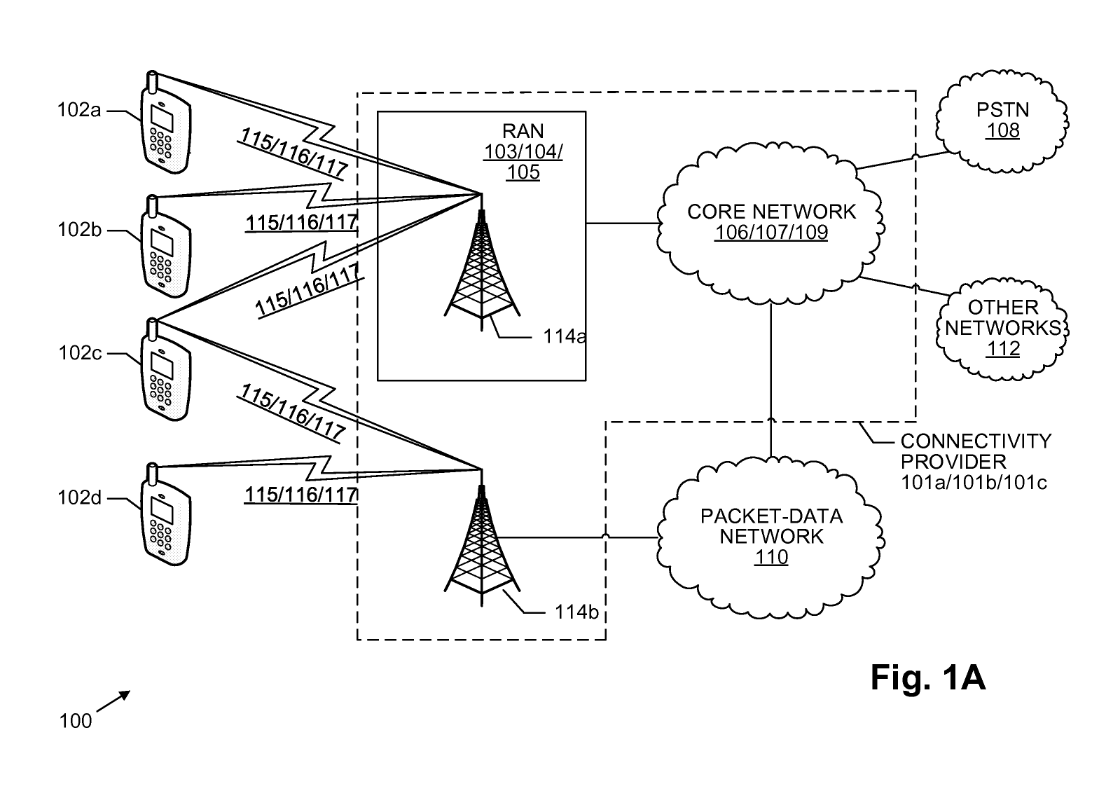

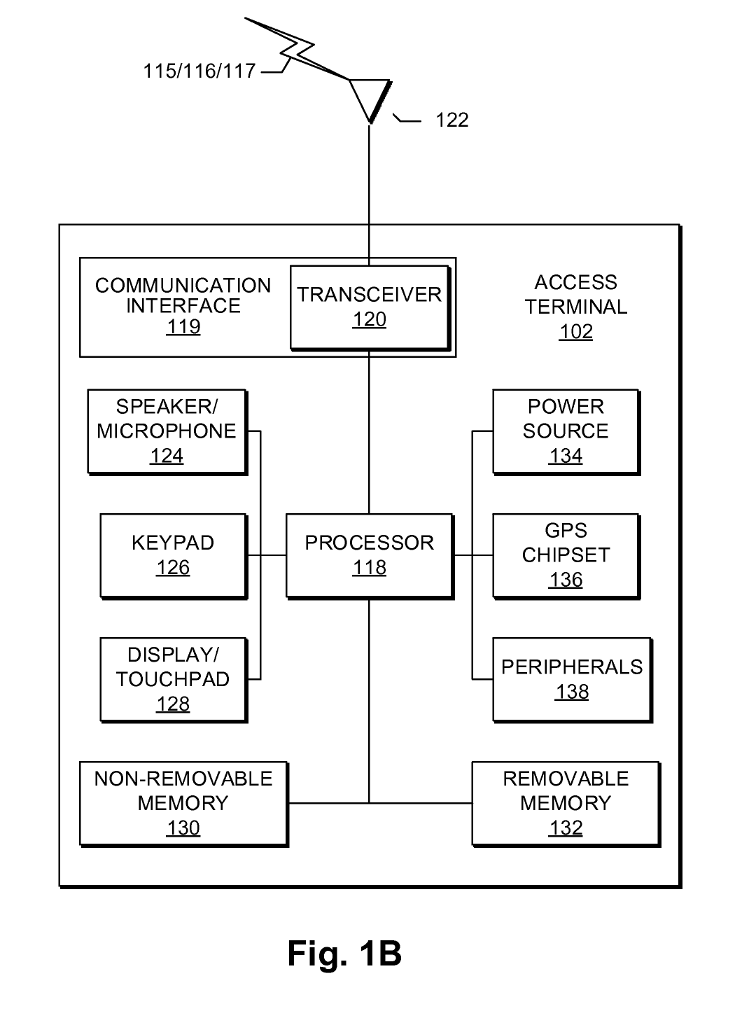

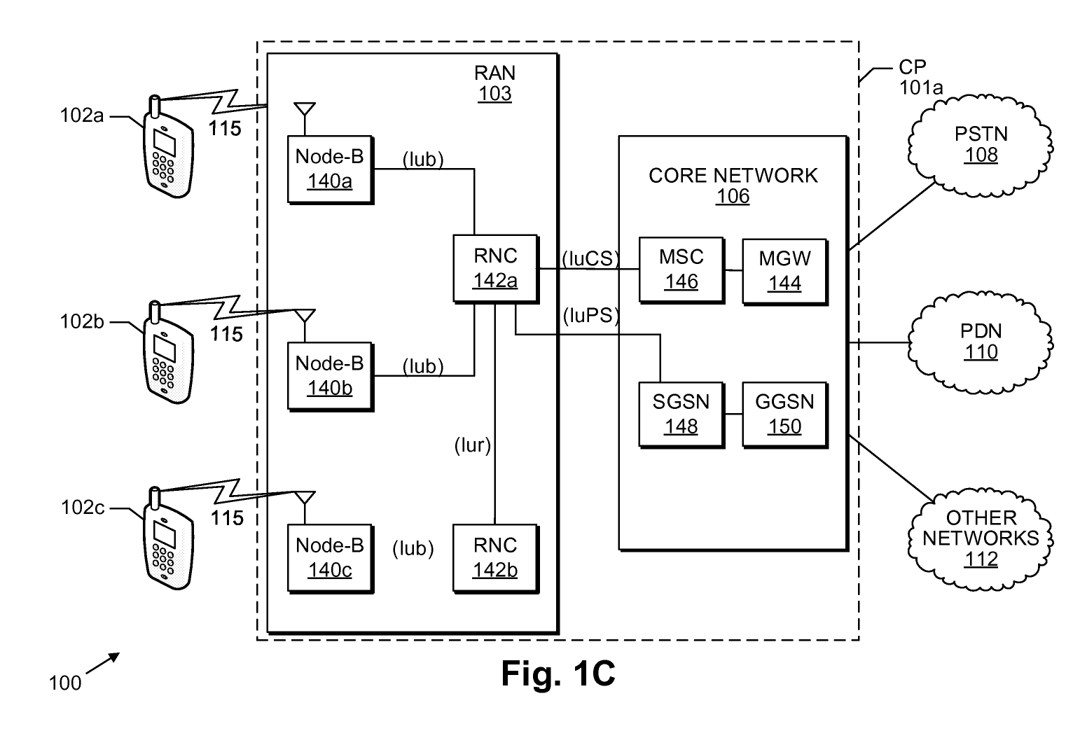

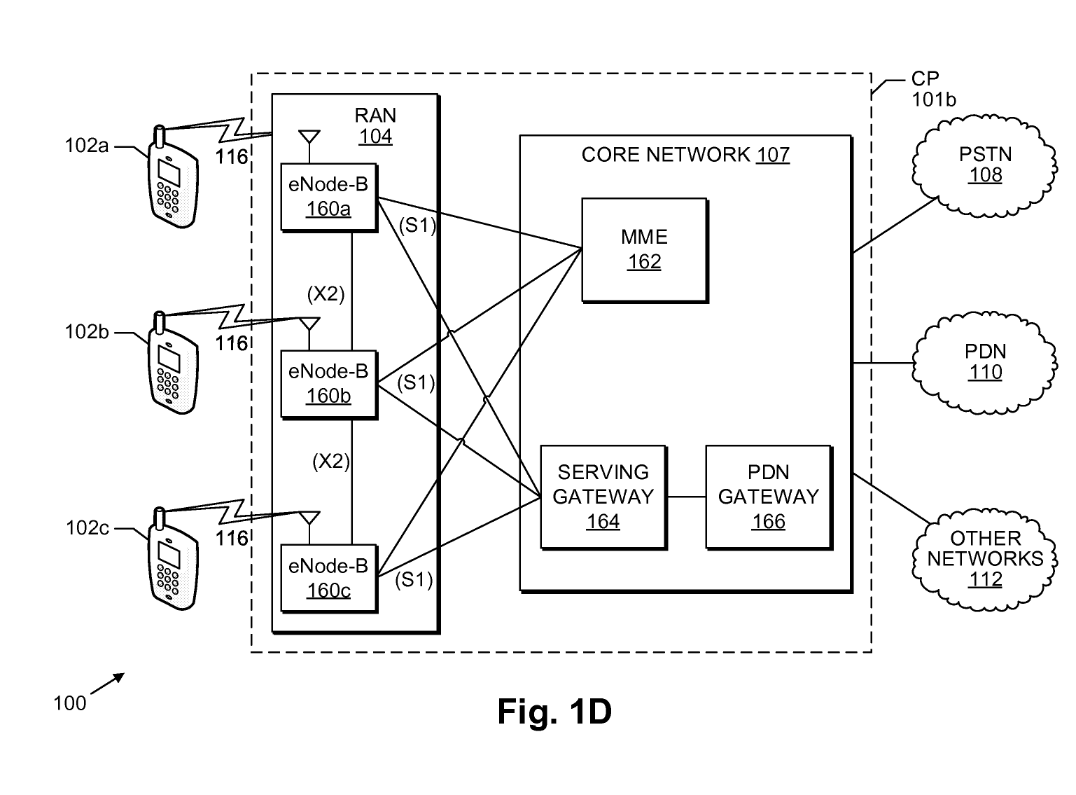

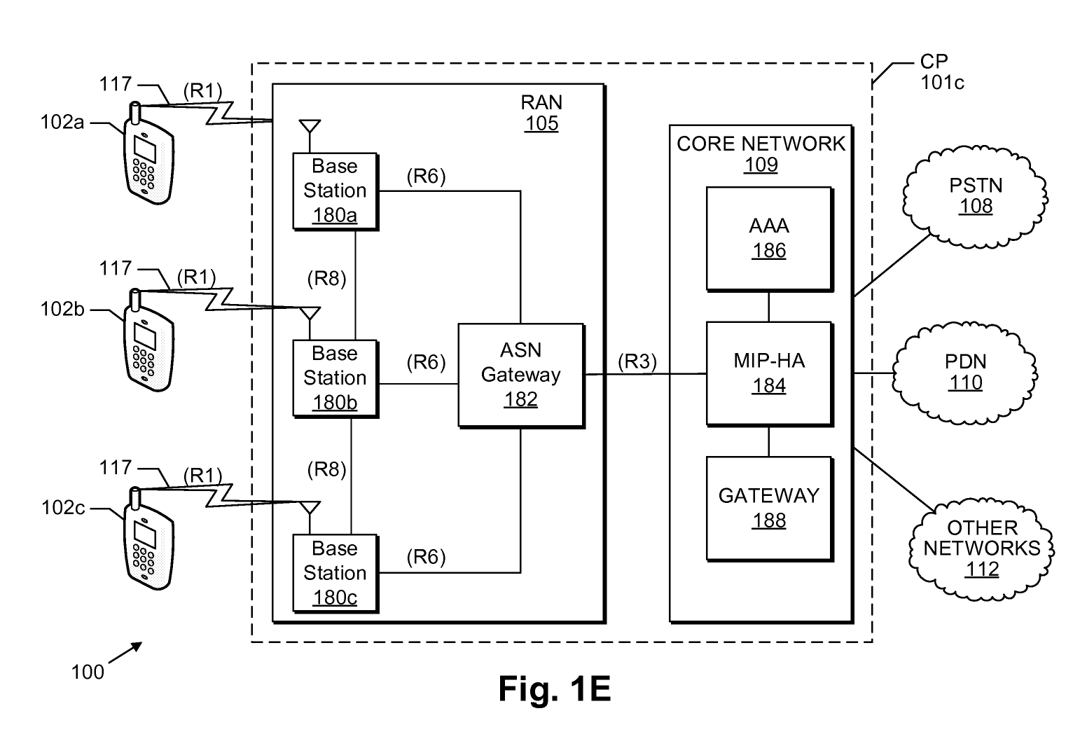

FIG. 1A is a diagram of an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel-access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, and/or 102d (which generally or collectively may be referred to as WTRU 102), a RAN 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, and the like). The air interface 115/116/117 may be established using any suitable radio access technology (RAT).

More specifically, as noted above, the communications system 100 may be a multiple access system and may employ one or more channel-access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, as examples, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, and the like) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. As examples, the core network 106/107/109 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and IP in the TCP/IP Internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, a non-removable memory 130, a removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer-loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements is depicted as a part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional landline communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between the WTRUs 102a, 102b, 102c and IP-enabled devices.

As noted above, the core network 106 may also be connected to the networks 112, which may include other wired and/or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio-resource-management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management entity (MME) 162, a serving gateway 164, and a packet data network (PDN) gateway 166. While each of the foregoing elements is depicted as a part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode-B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional landline communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired and/or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility-management functions, such as handoff triggering, tunnel establishment, radio-resource management, traffic classification, quality-of-service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point (not shown), which may be used for authentication, authorization, IP-host-configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility-management capabilities, as examples. The core network 109 may include a mobile-IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA 184 may be responsible for IP-address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional landline communications devices. In addition, the gateway 188 may provide the WTRUs 102a, 102b, 102c with access to the networks 112, which may include other wired and/or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point (not shown), which may include protocols for coordinating the mobility of the WTRUs 102a, 102b, 102c between the RAN 105 and the other ASNs. The communication link between the core network 109 and the other core networks may be defined as an R5 reference point (not shown), which may include protocols for facilitating interworking between home core networks and visited core networks.

In various embodiments described herein, communication networks are dynamically configured and parallelize application servers are configured to improve a Quality of Experience (QoE). In some embodiments, the configuration adjustments and alterations are done in real-time to support multi-user online environments. The environments may also be interactive and highly dynamic applications, and wherein the QoE is improved (optimized with respect to one or more criteria) through the use of policy based decision engines that control either the communication network configuration such as to minimize latency and packet errors and/or the distribution and parallel implementation of the application across multiple servers to minimize run-time, latency and power, and to dynamically support varying numbers of users.

Disclosed in one embodiment is a method and a system that obtains a composite state of the network, which may include numerous attributes including the application type, user specific-data, and the like, and responsively modifies the communication system and or application deployment such as by re-configuring the communication network and/or re-distributes the app server locations, and/or modifying the resources available to individual users.

In various embodiments described herein, a composite state may be obtained for processing by an optimization server. The composite state used by the systems described herein may include a global state and a local state. In some embodiments, the global state may include a Time-of-Day parameter, and a Game Type parameter. The game type may also have an associated Game Partition parameter and/or a Distribution Criteria parameter, and/or a Zoning parameter. Further global state variables may include a Number of Servers in Use parameter, a Number of Servers Available parameter, an Aggregate Server Power Consumption parameter, an Aggregate Network Power Consumption parameter, a Monetary Cost of Server Resources parameter, a Monetary Cost of Network Resources parameter, among others.

Local state variables may include client specific state variables and server-specific state variable. Client-specific state variables may include Network Link Quality variables such as a Latency parameter, a Network Connection Quality (Packet Error Rate) parameter, a Type of Network parameter (such as Wired/Wireless and/or Bandwidth/Throughput), a Location parameter, a Local Time of Day parameter, and a Power utilization parameter. Further client-specific state variables may include User Profile variables such as a Game Play Behavior parameter (Active, Aggressive, Passive), a Team Oriented/Loner parameter, a Display capability parameter, and a CPU capability parameter. Server Specific States may include a CPU/Memory Capability parameter, a Loading parameter (e.g., a percent consumption of computing resources, number of communication sessions, etc.), a Network Connection Quality parameter, a Geographic Location of Server parameter, a Usage fee parameter, and a Power utilization parameter.

Disclosed in a further embodiment is a system and a method that applies pre-defined policies to optimize the reliability and latency between multiple, interactive users and multiple servers that host a distributed implementation of an application based on dynamic global and local states and policies.

The Optimization Policies that are used by the decision engine are based on various criteria. In some embodiments, Global Criteria may be used to maximize a number of players and to increase a Quality of Experience. The QoE may be increased by improving a Synchronization Quality (which may be Loosely or Tightly Synchronized), improving a Real Time Loop Period/Frequency, or improving Network Quality by decreasing Latency. The system may also utilize a Prioritized Player List such that different service levels may be provided including a Platinum, Gold, Silver, and Bronze level.

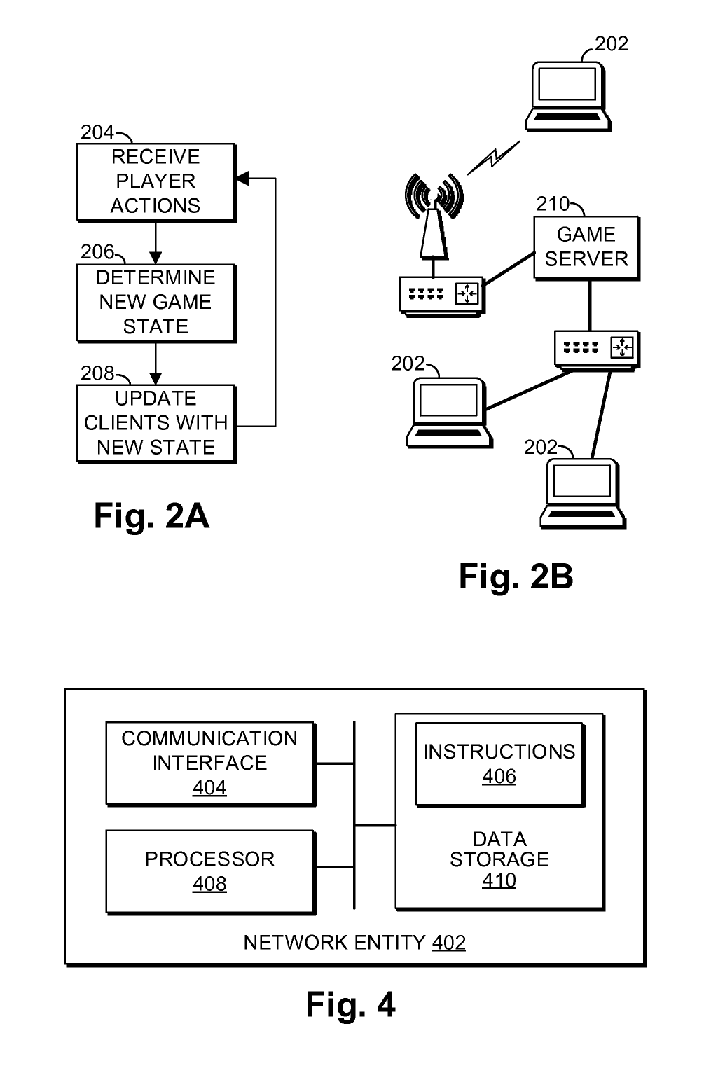

With reference to FIG. 2B, user equipment 202 may connect to a server 210 to engage in a multiplayer game. A dynamic game state is stored at the game server 210 and includes information representing avatar movements and action. In the system of FIG. 2B, player actions are received in step 204 (FIG. 2A) at the server 210. The server determines a new game state and then transmits the new game state to the clients in step 208 (FIG. 2A).

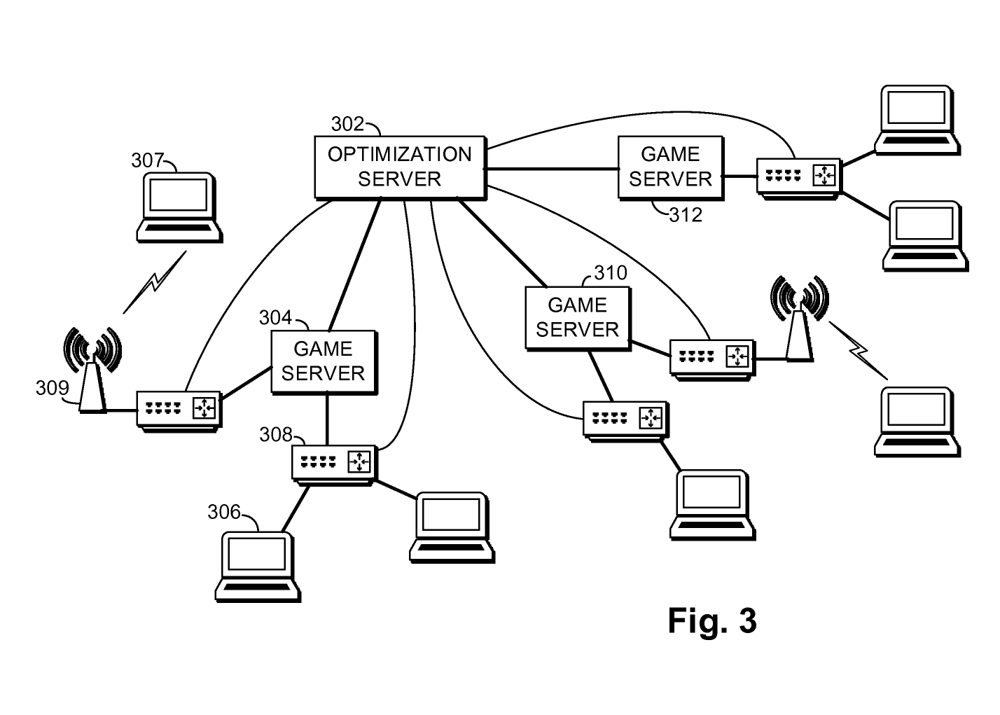

With respect to FIG. 3, the optimization server 302 is depicted as connected (via suitable networking infrastructure, such as routers and switches as may be necessary) to the game servers 304, 310, and 312. User equipment 306 is connected to game server 310 by way of switch/router 308 as one example. As another example, user equipment 307 is connected to the game server 310 by way of a wireless access point 309.

FIG. 4 depicts an example network entity 402 that may be used within the communication system 100 of FIG. 1A. As depicted in FIG. 4, network entity 402 includes a communication interface 404, a processor 408, and non-transitory data storage 410, all of which are communicatively linked by a bus, network, or other communication path.

Communication interface 404 may include one or more wired communication interfaces and/or one or more wireless-communication interfaces. With respect to wired communication, communication interface 404 may include one or more interfaces such as Ethernet interfaces, as an example. With respect to wireless communication, communication interface 404 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 404 may be equipped at a scale and with a configuration appropriate for acting on the network side—as opposed to the client side—of wireless communications (e.g., LTE communications, Wi-Fi communications, and the like). Thus, communication interface 404 may include the appropriate equipment and circuitry (perhaps including multiple transceivers) for serving multiple mobile stations, UEs, or other access terminals in a coverage area.

Processor 408 may include one or more processors of any type deemed suitable by those of skill in the relevant art, some examples including a general-purpose microprocessor and a dedicated DSP.

Data storage 410 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 4, data storage 410 contains program instructions 406 executable by processor 408 for carrying out various combinations of the various network-entity functions described herein. The network entity 402 may be used to implement an optimization server as described herein.

As will be appreciated by one skilled in the art, aspects of the present disclosure and of the network entity 412 may be embodied as an apparatus that incorporates some software components. Accordingly, some embodiments of the present disclosure, or portions thereof, may combine one or more hardware components such as microprocessors, microcontrollers, or digital sequential logic, etc., such as processor 408 with one or more software components 406 (e.g., program code, firmware, resident software, micro-code, etc.) stored in a tangible computer-readable memory device such as memory 410, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, and the like. A given module may even be implemented such that the described functions are performed by separate processors and/or computing hardware platforms.

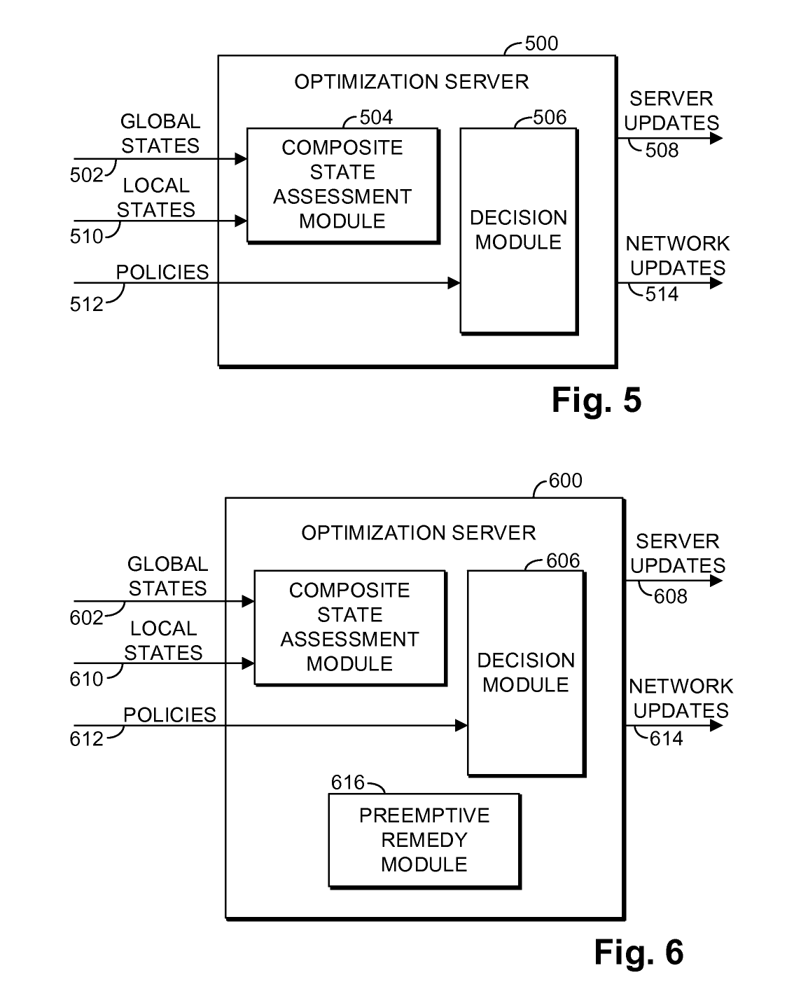

With reference to FIG. 5, the optimization server 500 will be described. The optimization server 500 receives numerous inputs, including global state information on input 502, local state information on input 510, and policy input on input 512. Note that the various inputs are a logical representation of the different inputs, while the physical implementation of the server 500 may accept all of the inputs 502, 510 and 512 on a communication interface 404. The composite state assessment module 504 accesses the global and local state information and determines if the changed variables indicate a QoE degradation. If so, the decision engine module 506, which receives the policy data input 512, processes the state information to determine server updates 508 and/or network updates 514.

With reference to FIG. 6, a Preemptive QoE Degradation Avoidance Decision Engine will be described. The optimization server 600 receives numerous inputs, including global state information on input 602, local state information on input 610, and policy input on input 612. A machine-learning-based QoE preemptive remedy module 616 analyzes state variable changes associated with determinations or measurements of QoE degradation. The preemptive remedy module 616 thus identifies scenarios (state variable conditions and transitions) that tend to result in QoE degradations. In some embodiments, the preemptive remedy module 616 updates the composite state assessment module 604 to identify such conditions and to trigger the actions of decision engine 606 according to the newly identified state conditions/transitions. The composite state assessment module 604 accesses the global and local state information and determines if the changed variables indicate an anticipated QoE degradation. If so, the decision engine module 606, which receives the policy data input 612, processes the state information to determine server updates 608 and/or network updates 614.

As described herein, various types of information are transferred between the server and the clients. The information may include player commands/moves, game state updates, chat, audio flows for player communication, 3D data, video (streaming of game sessions), among others.

In such an environment, quality of experience for users of the system may degrade due to a number of factors. These include the server having insufficient processing power to calculate the next state, the uplink network having too much latency or insufficient bandwidth to convey player updates in time, the downlink network having too much latency or insufficient bandwidth to convey state update in time, and/or the client having insufficient processing power to properly render the graphics or update the local game state.

More specifically, the issues that degrade QoE of real-time interactive multi-user applications involving resource intensive application may include: Excessive Latency; Latency Jitter; Insufficient Network Bandwidth; Insufficient Server Processing Capability; Insufficient Client Processing Capability.

Some attempts at alleviating these problems have included Area-of-Interest filtering and delta-encoding, which are two common optimizations performed by server-implemented games. Players typically interact with a subset of the game world at a given time. A server only needs to update a client about objects in its Area-of-Interest. Also, the set of objects and their state change infrequently in a given game ‘frame’, reducing the amount of information which has to be transferred in a frame.

However, as the number of users increases, the Area-of-Interest filtering operation can become a bottleneck. Also, as the number of users increases, the bandwidth demand of the server increases in a non-linear manner, since as the number of players increases, player interaction increases. Bharambe, A Distributed Architecture for Interactive Multiplayer Games, Pittsburgh, Pa.: School of Computer Science, Carnegie Mellon University (2005), the contents of which are hereby incorporated herein by reference.

In a further embodiment, disclosed is a method and system that determines an application partition and distributes the executable implementation of an application across multiple servers and server locations to optimize run-time and latency through the use of a decision engine that analyzes dynamic global and local states and policies.

Distribution of the game engine logic between the player and the server can mitigate the degradation of the players' quality of experience because each player sees zero latency on their moves. Further, Players are more resilient to latency, latency jitter and packet loss since their local game engine will interpolate missing input. Distribution also enables less information to be transmitted, less frequently.

Distribution of the server engine can be performed across multiple servers by use of partition of the game state based on objects. The collection of mutable objects such as player avatars, projectiles, explosions and other movable artifacts represents the overall dynamic game state. The collection of the mutable objects can be partitioned and then processed across multiple servers

In still further embodiments, a method and system is described that utilizes a decision inference engine to make preemptive changes to the communications network and/or multiple server configurations to avoid quality of experience degradation based on global and local state, past (learned) performance and policies.

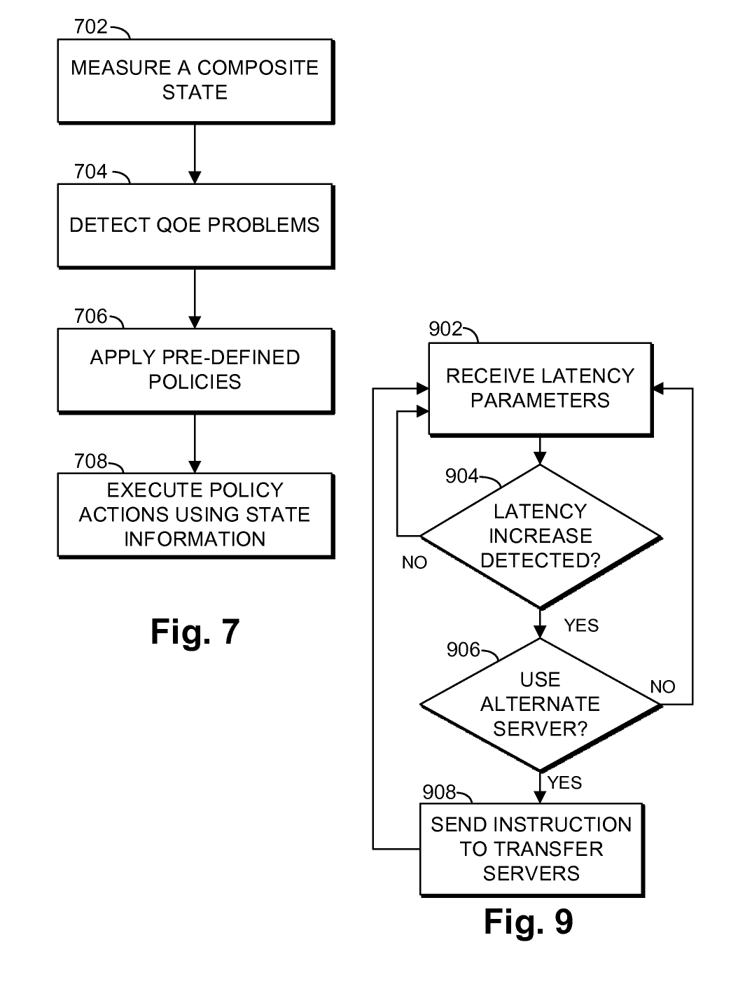

In one embodiment shown in FIG. 7, a method 700 may include: measuring a composite state (702). The measurement of the composite state may include the relevant state of the network(s), the relevant state of the application server(s), and the relevant state of the user. The method may also include the detection of QoE problems (704). The detection may include using pre-defined methods. The method may also include the application of pre-defined policies (706) in order to remedy the detected QoE problems in real time. The method may also include the execution of the actions that are put forth by the policies using state information and optimization approaches (708). In some embodiments, this may include predictive information.

In various embodiments, the corrective action(s) take into account information about the networks, the application, the user device and the user behavior. In one embodiment, the user's local broadband wired network experiences higher latencies. Corrective actions based on the policy may include (i) moving the game to a server closer to the user to minimize latency, (ii) decreasing the game frame rate, (iii) decreasing the number of mutable-objects within the users local view of the game's virtual world, and (iv) switching to a different network such as broadband cellular, mmWave/5G, wired broadband.

In a further embodiment, the user's broadband network experiences higher latency at a certain time of day. Preemptive actions taken based on historical data, may include (i) moving the game to a server closer to the user to minimize latency, (ii) decreasing the game frame rate, (iii) decreasing the number of mutable-objects within the users local view of the game's virtual world, and/or (iv) switching to a different network such as broadband cellular, mmWave/5G, wired broadband.

In a further embodiment, when additional users enter the game, the policy implemented by the server may include taking corrective actions such as partitioning and distributing the game across more game servers.

In a further embodiment, when users leave the game, the policy implemented by the server may include (i) consolidating the game onto fewer servers, (ii) increasing the number of mutable-objects with the users' local view of the game's virtual world.

In a further embodiment, when network or link bandwidth decreases, the policy implemented by the server may include (i) decreasing an area of interest for each user, (ii) decreasing a number of mutable objects associated with each user, (iii) partitioning a virtual world further and distribute the game application to servers closer to clients, and (iv) decreasing a frame rate.

In a further embodiment, when network bandwidth increases, the policy implemented by the server may include (i) increasing an area of interest for each user, (ii) increasing a number of mutable objects associated with each user, and (iii) consolidating the game distribution across fewer servers. In some embodiments this may include utilizing more servers in a centralized data center versus edge-based servers.

In a further embodiment, when a number of available servers increases, the policy implemented by the server may include (i) utilizing appropriate options as described above to optimize users' QoE and system operation. When a number of available servers decreases, the server may similarly utilize appropriate options as described above to optimize users' QoE and system operation.

In a further embodiment, the policy implemented by the server may include power optimization criteria. In such an embodiment, the system optimizes the utilization of servers and the network to minimize overall power consumed. That is, the system may utilize appropriate options as described above to optimize power, users' QoE and system operation.

In further embodiments, when a user obtains more sophisticated game level and/or obtains more objects, etc., then the policy server may utilize appropriate options as described above to optimize users' QoE and system operation. On the contrary, if it is determined that the user is cheating, the policy engine may (i) remove the user from the game, (ii) reduce the user's associated number of mutable objects (reduced capabilities), or (iii) reduce the user's network link quality (i.e. lower bandwidth, higher latency). Finally, if the user is not participating, the policy server may (i) remove the user from the game, or (ii) reduce the user's capabilities (i.e. reduce associated CPU load).

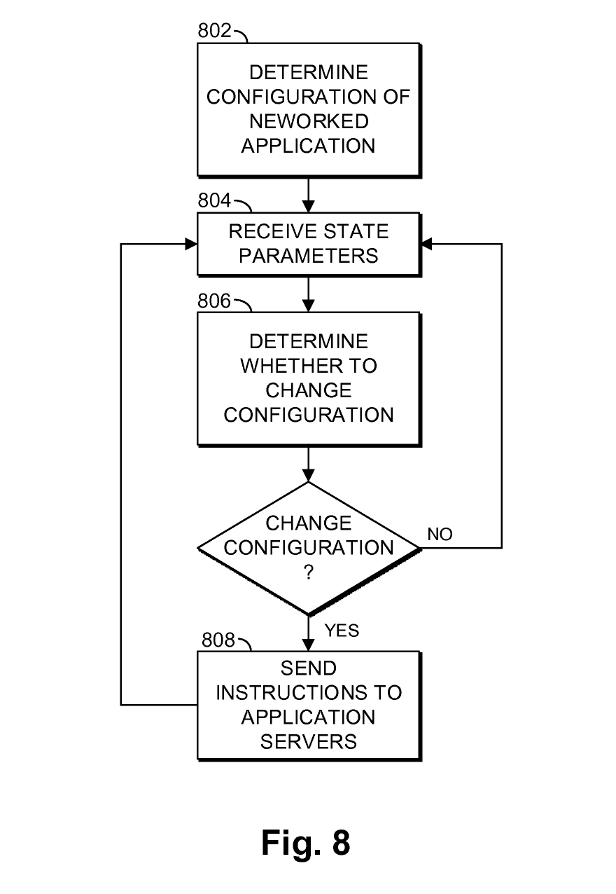

An exemplary embodiment is illustrated in FIG. 8. In step 802, the optimization server determines the configuration of the networked application, such as a distributed multi-player gaming application. The configuration of the distributed application may include information such as a mapping between users and game servers, a game frame rate, a number of mutable objects in a virtual world associated with a user of the game, an area of interest for users of a game server, and the identities and characteristics of communication networks connecting users with respective game servers, among other characteristics representing a configuration of the network.

In step 804, the optimization server receives state parameters representing the state of the network. The state parameters may include information on the upstream and/or downstream latencies experienced by users of respective application servers. The state parameters may also include information on the loading of the various application servers (e.g., a percent consumption of computing resources, a number of communication sessions or other value or combination of values reflecting the degree of engagement of the resources of the application server). The state parameters may be sent to the optimization server as messages from the application servers, from the users, or from both the users and the application servers.

The optimization server can receive network state information, such as latency and jitter information, in various different. In some embodiments, the state information can be streamed to the optimization server from a persistent data storage where this information is collected and stored. The state information can be retrieved by actively pulling this information from a storage database as needed. The timing of such information retrieval can be based on policies or criteria that depend on events happening in other parts of the systems, e.g., application-specific or game-specific events such as the user losing a game. Alternatively, or in addition, the information retrieval can be performed at specific time intervals (e.g., every 5 minutes). In some embodiments, the network state information is pushed to the optimization server at pre-defined time intervals or on the occurrence of events such as a change in jitter or delays. The persistent data storage may support various queries and may also be operative to perform operations on raw data, such as computing jitter and delays. The persistent data storage may also support an administrative interface which allows authorized administrators to specify the push/pull/streaming policies, the content of the information to be streamed, and the operations (calculations) to be performed on the raw data.

In step 806, the optimization server, based on a quality of experience policy, determines whether to change the configuration of the network. For example, a quality of experience policy may indicate that one or more additional application servers should be added when a load parameter of an application server already in use rises above a threshold level. Some of the users may then be transferred to the new application server. A quality of experience policy may indicate that, under conditions of high loading, a game server reduces the frame rate of the game, lowers the number of mutable objects in the game, and/or decreases the area of interest of players in the game.

A quality of experience policy may indicate that when a user experiences latency above a threshold level, the user should be reassigned to a different application server located nearer to the user. In such an embodiment, the optimization server determines that a proposed server is closer than the current server to the user before effecting the transfer. In some embodiments, a quality of experience policy may indicate that, in response to a high latency parameter, a different communication network should be used to connect the user to the application server. The latency parameter may be based on the latency of communications from at a user to the application server, communications from the application server to the user, or both. For example, the latency parameter may be a weighted running average of a sum of latencies to the application server and from the application server.

A quality of experience policy may also provide indications of when to changes to the network configuration are reversed. For example, after application servers have been added, the quality of experience policy may indicate that, when load parameters are sufficiently reduced (e.g., below a threshold), one or more application servers should be removed, and all users assigned to the removed application servers should be reassigned to at least one other server. Similarly, the policy may indicate that, when sufficient resources are available (e.g., the loading parameter is sufficiently low), the game frame rate should be increased, an area of interest should be increased, and/or a number of mutable objects should be increased. When latencies are sufficiently low, users may be assigned to servers that are farther away, particularly if this results in other economies (for example, fewer servers may be used, even if this results in a greater average distance from user to server).

A determination to change the configuration of the distributed gaming network may be based at least in part on a lowered quality of experience of at least one of the users. In some embodiments, a determination to change the configuration of the distributed gaming network may be based at least in part on a predicted lowering of a quality of experience of at least one of the users. A prediction of an expected lowering in quality of experience may be based at least in part on historic information regarding lowering of a quality of experience. For example, an optimization server may store information indicating that, at a particular time of day on particular days of the week, servers tend to become overloaded, or latency of communications tends to increase. The optimization server may operate to change the configuration of the networked application to accommodate predicted changes in users' quality of experience.

Once a decision has been made to change the configuration of the networked application, the optimization server in step 808 sends instructions to the appropriate application servers to carry out the changes to the configuration, such as instructions to hand off users to other servers, instructions to transfer users to other communications networks, or instructions to change the game frame rate, number of mutable objects, or area of interest.

Another exemplary embodiment is illustrated in FIG. 9. In step 902, the optimization server receives latency parameters that represent communication latencies between an application server and a plurality of users of the application server. The latency parameters may be based on the latency of communications from at a user to the application server, communications from the application server to the user, or both. For example, the latency parameters may be a weighted running average of a sum of latencies to the application server and from the application server. In step 904, the optimization server detects a latency increase in the latency parameter of at least one of the users. The latency increase may be detected when the latency parameter increases above a threshold parameter, or when, for example, the latency parameter of a user increases by more than a threshold percent above an average latency experienced by the user. Other triggers for detecting a latency increase may alternatively be used.

In step 906, the optimization server determines whether a different application server would have a lower predicted communication latency, at least for the user for whom increased latency was detected. The determination of a lowered predicted communication latency may be based on the geographic location of the application servers, with communication latency predicted to be lower for application servers closer to the relevant user. The determination of a lowered predicted communication latency may be based on historic latencies measured between the proposed server and the user or may be based on information regarding a communication network between the user and the proposed server or other information.

In some embodiments, a determination to transfer a user to a server with lower expected latency may be made only after determining that the loading parameter of the second application server is below a threshold loading parameter. This can be done to prevent overloading of servers that are located relatively near to a large number of users. More complicated quality of experience policies may also be implemented that balance potential latency improvements versus loading of different application servers.

In step 908, in response to the determination to use an alternate server, the optimization server sends an instruction or instructions to effect the transfer. The instruction may be sent to the original server, the new server, and/or the user as required to effect the transfer.

A range of networked applications can benefit from the system and methods described here, in particular but not limited to mobile apps. This includes but is not limited to: Massive Multiplayer Online Games such as Role Playing Games and First Person Shooter Games; Broader non-game classes of applications that benefit from real-time behavior; Online, interactive, multiuser Learning applications; Real time video teleconferencing; and Collaborative Robotic Operations such as remote Surgery

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by an optimization server comprising:
determining a configuration of a networked gaming application having a plurality of game servers, wherein the configuration includes at least a mapping between users and game servers;
receiving a plurality of state parameters, including at least loading parameters of a plurality of game servers and latency parameters of a plurality of users of the respective game servers;
based on a quality of experience policy, determining whether to change the configuration of the networked gaming application; and
in response to a determination to change the configuration of the networked gaming application, sending an instruction to at least a first game server to change the configuration of the networked gaming application.

2. The method of claim 1, wherein the configuration further includes a game frame rate, and wherein the instruction is an instruction to the first game server to change the game frame rate.

3. The method of claim 1, wherein the instruction is an instruction to transfer at least a first user from the first game server to a second game server.

4. The method of claim 3, further comprising determining that the second game server is closer than the first game server to the first user.

5. The method of claim 1, wherein a determination to change the configuration of the networked gaming application includes a determination to add at least one additional game server, and wherein the instruction is an instruction to transfer at least a first user to the additional game server.

6. The method of claim 1, wherein a determination to change the configuration of the networked gaming application includes a determination to remove the first game server, and wherein the instruction is an instruction to transfer all users of the first user to at least one other game server in the plurality of game servers.

7. The method of claim 1, wherein the configuration further includes a number of mutable objects in a virtual world associated with a user of the game, and wherein the instruction is an instruction to change the number of mutable objects.

8. The method of claim 1, wherein the configuration further includes an area of interest for at least a first user of the first game server, and wherein the instruction is an instruction to change the area of interest of the first user.

9. The method of claim 1, wherein the configuration further includes an identity of a first communication network connecting at least a first user with the first game server, and wherein the instruction is an instruction to transfer the user to a second communication network.

10. The method of claim 1, wherein a determination to change the configuration of the networked gaming application is based at least in part on a lowered quality of experience of at least one of the users.

11. The method of claim 1, wherein a determination to change the configuration of the networked gaming application is based at least in part on a predicted lowering of a quality of experience of at least one of the users.

12. The method of claim 11, wherein the predicted lowering of a quality of experience is based at least in part on historic lowering of a quality of experience.

13. The method of claim 1, wherein the latency parameters include information identifying a latency of communications from at least a first user to the first game server.

14. The method of claim 1, wherein the latency parameters include information identifying a latency of communications from the first game server to at least a first user.

15. A method performed by an optimization server, the method comprising:
receiving, from each of a plurality of application servers, information representing a communication latency between the application server and a plurality of respective users of the application server;
detecting an increase in communication latency for at least a first user of a first application server;
in response to detection of the increase in communication latency, identifying a second application server having a lower predicted communication latency for the first user; and
sending to the first application server an instruction to transfer the first user to the second application server.

16. The method of claim 15, wherein the application servers are game servers in a distributed gaming network.

17. The method of claim 15, wherein identifying the second application server includes determining that the second application server is closer than the first application server to the first user.

18. The method of claim 15, further comprising receiving a loading parameter from at least the second application server, wherein the instruction to transfer the first user to the second application server is sent only after determining that the loading parameter of the second application server is below a threshold loading parameter.

19. An optimization server comprising a processor and a non-transitory computer-readable storage medium, the storage medium storing instructions that are operative, when executed by the processor:
to determine a configuration of a distributed gaming network having a plurality of game servers, wherein the configuration includes at least a mapping between users and network servers;
to receive a plurality of state parameters, including at least loading parameters of a plurality of application servers and latency parameters of a plurality of users of the respective application servers;
based on a quality of experience policy, to determine whether to change the configuration of the distributed gaming network; and
in response to a determination to change the configuration of the distributed gaming network, to send an instruction to at least a first game server to change the configuration of the distributed gaming network.

20. The optimization server of claim 19, wherein the instruction is an instruction to transfer at least a first user from the first game server to a second game server.
